(19) United States
(12) Patent Application Publication
(10) Pub. No.: US 2005/0240970 A1
(43) Pub. Date: Oct. 27, 2005

(54) Guess room interactive television system and method for carrying out the same

(76) Inventors: Andrew P. Schwalb, Mt. Dora, FL (US); Kyle P. Hanley, Orlando, FL (US); Kevin Rice, Altadena, CA (US); Frank Farro, Celebration, FL (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/109,287

(22) Filed: Apr. 18, 2005

Related U.S. Application Data
(60) Provisional application No. 60/564,911, filed on Apr. 22, 2004.

(51) Int. Cl. H04N 7/18; H04N 5/445; G06F 13/00

(52) U.S. Cl. 725/78; 725/74; 725/39

(57) ABSTRACT

A system and method for utilizing an interactive television system in a hotel room at a venue to provide a guest at the venue with a tour guide to the venue. The tour guide includes a virtual concierge for use by the guest while staying at the hotel and while visiting the venue. The tour guide also includes a virtual photographer guide to the venue enabling the guest to view photographs taken of the guest and/or his family and friends when visiting the venue.

### CROSS REFERENCE TO RELATED APPLICATION

This application claims the benefit of provisional application Ser. No. 60/564,911, filed Apr. 22, 2004, the contents of which are incorporated by reference herein in their entirety.

### BACKGROUND

1. Field of the Disclosure

The present disclosure relates generally to an interactive television system and method for use in a room in a hotel or the like.

2. Description of the Prior Art

Attending amusement parks and the like should be a fun and entertaining experience. Many guests to such parks stay at hotels related to the park. The hotels in such venues try to make the guest's visit to the park as hassle free as possible. Some hotels, not only those associated with amusement parks or the like, provide in-room entertainment and informative interactive content through the room's television set to enhance the stay of the guest.

### SUMMARY OF THE DISCLOSURE

An objection of this disclosure is to provide guests to a hotel with entertaining and informative interactive content to help reduce hassle during the guest's visit and enhance the guest's vacation experience.

It is a further object of this disclosure to utilize characters associated with a venue, such as an amusement park, to provide such information services.

It is still another object of this disclosure to provide such a service as in the foregoing objects which assists the guests in planning their activities while at the venue or answering any of the guest's questions.

The present disclosure is a system which enhances a guest's visit to a venue, such as an amusement park. Various characters associated with the venue, and characters created solely for the system herein, can be utilized to carry out the disclosure herein.

The system will play three important roles: Tour Guide, Concierge and Photographer.

As a Tour Guide, the system will lead the guest through a personalized tour of what there is to see and do at the venue. The guest will be able to view on-demand video clips relating to the venue in the guest's room over the television set, such as various parks or amusement sections associated with the venue, and even other venues not physically located where the hotel is but both associated with the hotel and other venues of interest not related to the hotel and its related venue. The guest's individual preferences may be entered into the system and the guest may be able to view video clips providing the best parts of the venue for that guest's particular preferences. The guest will be able to obtain additional information about any of the information displayed in the video clips by merely touching a button or the like on a television remote control, such as show times, special events and attraction-specific information.

The concierge role of the system will assist the guest in planning their time at the venue, such as dining reservations, transportation information and ticket-purchase application.

The Photographer role of the system will enable the guest to view all photographs taken of the guest and his or her family during their stay at the hotel. Provisions may be available on the system to edit such photographs or purchase the same or even allow the guest to share the photographs with others, such as by email or the like to family members or friends not at the venue.

In all of the above, animated characters, newly created for the system or associated with the venue, and related audio and character voices may be used to add personality and color to the system. Further, the system may be multilingual allowing the guest to chose the language he or she is most comfortable with.

### BRIEF DESCRIPTION OF THE DRAWINGS

FIG. 1 is a diagrammatic representation of the overall Tour Guide of the disclosure;

FIG. 2 is a diagrammatic representation of the Concierge portion of the disclosure; and

FIG. 3 is a diagrammatic representation of the Photographer portion of the disclosure.

### DETAILED DESCRIPTION

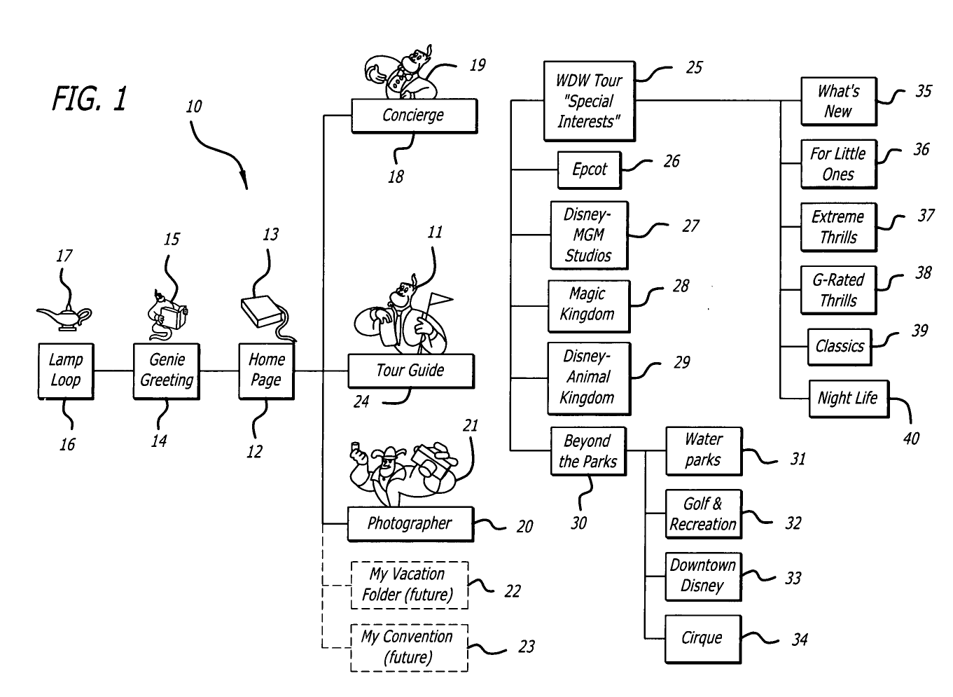

FIG. 1 thus is a flow chart illustrating the interactive features of the three parts of the system, Tour Guide, Concierge and Photographer.

The system disclosed in FIG. 1 contemplates using state of the art means to deliver high-speed data transmissions to a hotel's guest room. Such state of the art means should provide high-speed internet access via laptop computer and enhanced television-based content to drive Customer Relationship Management (CRM) initiatives and further differentiate an experience at the hotel in which the system of this disclosure is installed from experiences at other venues.

The benefits of the system disclosed herein include high-speed internet access via guest's laptop computer, the sale of products by the venue over the television, purchase of tickets directly over the television and on-screen phone number referral for other tickets. Other benefits may include business support using easy-to-navigate marketing videos, food and beverage sales, table service sales, hassle-reduction transportation assistance, tips and hints relating to the venue, products and services information, package entitlements descriptions, and information about the venue, such as an amusement park and related venues.

Thus, the Tour Guide system 10 in FIG. 1 may include a cartoon figure, such as genie 11, which introduces the guest to the program. The user, or guest, using the TV's remote control, can click on the homepage icon 12, to return to the home page at any time, denoted by character 13, or a genie greeting icon 14, denoted by Character 15, or lamp loop icon 16, denoted by lamp icon 17.

The user can navigate to the concierge 18, again denoted by character 19, or to the Photographer 20, denoted by character 21.

If desired, the user also has access to the My Vacation Folder 22, to book future vacations, or the MY CONVENTION box 23, to book future conventions at the venue.

From the Tour Guide box 24, the user, by checking on the same, will open a) a Special Interests box 25 (e.g., if Walt Disney World—WDW—is the venue, this box could be related to a special Tour there); b) Epcot® center box 26; c) Disneyland®—MGM® box 28; e) Disney's Animal Kingdom® box 29; and f) Beyond the Parks box 30. Clicking on this box will offer the guest 4 choices: Water Parks in the area-box 31; Golf and Recreation facilities in the area-box 32; Downtown Disney—box 33; and Cirque du Soleil, a circus attraction at the venue-box 34.

When the special tours box 25 is accessed, it opens boxes 35 through 40. Box 35 will show the guest what is new at the venue; box 36 will show the guest what is available for children at the venue; box 37 will show the guests what extreme or thrilling attractions are available at the venue; box 30 will do the same but show G-rated attractions; box 39 will display Classics-type attractions at the venue; and box 40 will show what Night Life, such as night clubs, etc., are available at the venue.

All of the foregoing may be accompanied by suitable text, sound, graphics, animation, video, etc.

If the user clicks on the Concierge box 18 in FIG. 1, the user opens up all of the features of the Concierge portion of the system.

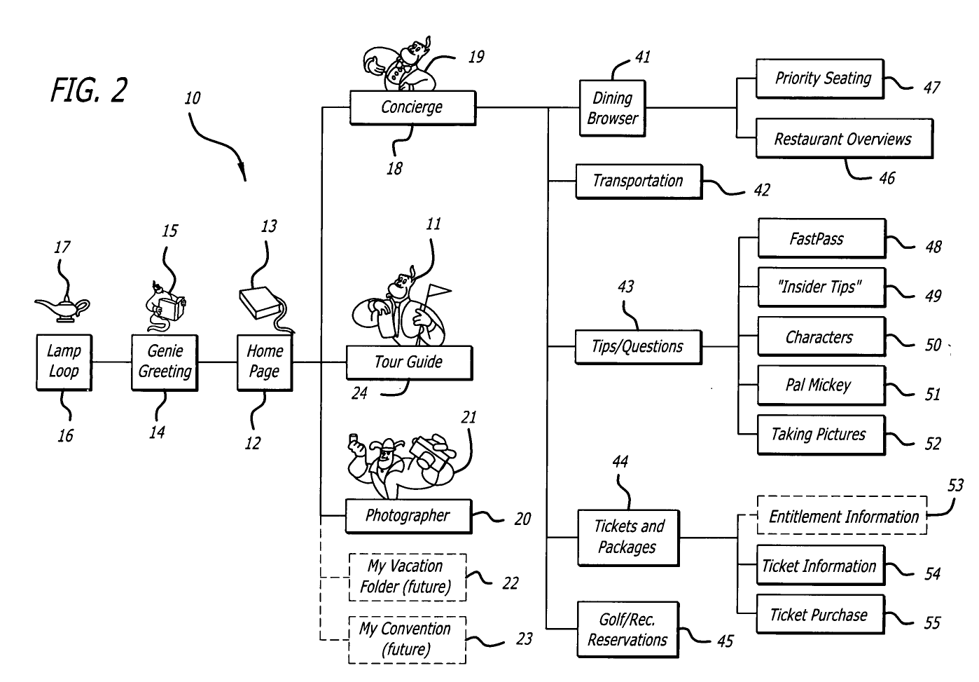

Thus, as seen in FIG. 2, wherein like numerals refer to like elements of FIG. 1, a dining browser box 41 is opened. Accessing this will allow the user to see what restaurants are available (box 46) and make priority seating reservations, if desired (box 47).

Opening box 43, Tips and Questions, the guest can see what Tips are available to better his or her stay. For example, box 48 will show the guest what the FASTPASS® ticketing system is and how to use it; the Insider Tips box 49 will provide tips to the guest to improve his or her stay; box 50 will show the Characters available at the venue (possibly their location, times, etc.), the PAL MICKEY box will show where the children's “PAL” Mickey Mouse® will be at the venue, and box 52 will point out scenic spots at the venue and photographic opportunities.

Accessing box 44, Tickets and Packages, will open boxes 53 to 55 (box 53, entitled ENTITLEMENT INFORMATION, shown in dotted lines, may not be accessible to all guests, only those “entitled” to certain amenities displayed here.) Box 54 will provide ticket information (e.g., fees, combinations, etc.), and Box 55 will allow the guest to purchase the same. Finally, accessing box 45 will allow the guest to see what golf and/or other recreations are available in the area and making reservations. Again, all accessed boxes may be accompanied by suitable test, graphics, sound, animation, etc.

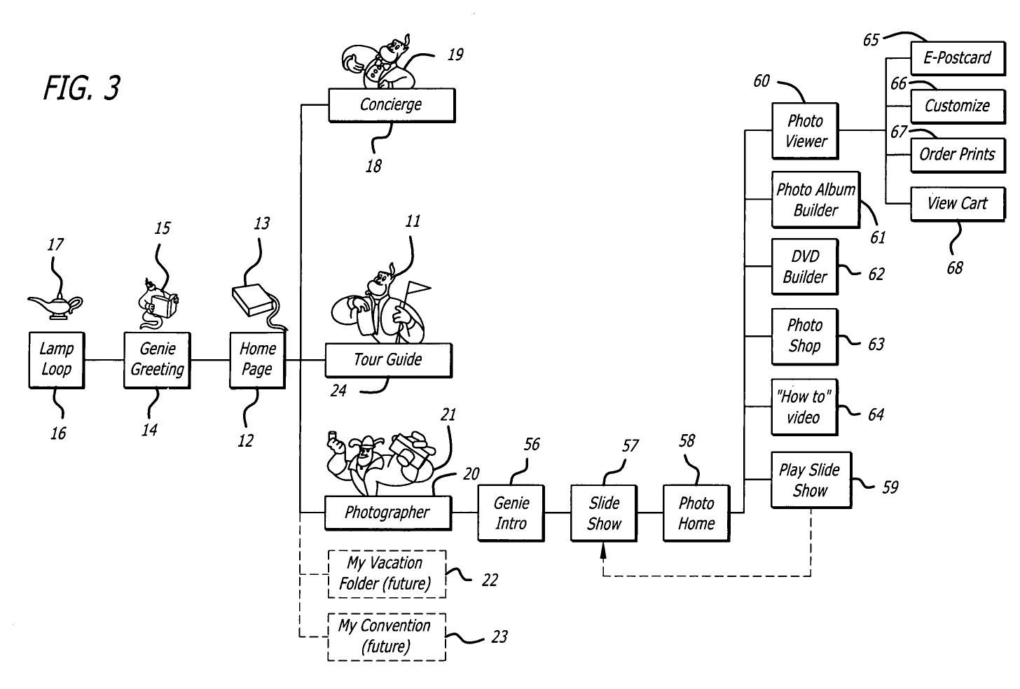

Looking again to FIG. 1, accessing box 20 will open the Photographer features shown in FIG. 3, where like numerals refer to like parts of the graphical illustration of FIG. 1.

Thus, accessing box 20 opens boxes 56 to 58. Box 56 may be an introduction from a character, as a genie, both animated and aural, and may play only the first time accessed. Box 52 may be a slide show that can be played when accessed or later (see box 59). Clicking on box 58, Photo home, opens boxes 60 through 64 and aforementioned box 59. Box 60 allows the guest to view photos the guest may have had taken at the venue. Opening this box opens boxes allowing the guest to email a photo in the form of a post card (box 65), customize a photo (box 66), order prints of a selected photo (box 67) and view the shopping cart containing the ordered photos and/or postcards (box 68).

The guest can access box 61 to make a photo album, access box 62 to make a DVD containing selected photos, view photos (box 63) at a photo shop (e.g., photos of the venue), and see a “how to” video by accessing box 64 which may show the guest how to make a video of the guest's visit to the venue. Again, the foregoing may be accompanied by text, graphics, sound, animation, etc.

The various boxes in FIGS. 1 to 3 represent certain actions taken by the guest using the guest's in-room television and a remote control for the television. Although the basic features of each box in FIGS. 1 to 3 has been described, certain specific features may be provided when a particular box is accessed. This is shown in the following Appendix the Index indicates numbered parts of FIGS. 1 to 3. For example, 1.0 refers to the Introduction portion of the system present in FIGS. 1 to 3.

APPENDIX

| Index | |
|---|---|
| 1.0 | Intro Animated Clips and Interstitial Elements |
| 2.0 | Concierge |
| 2.1 | Dining Finder |
| 2.2 | Transportation Finder |
| 2.3 | Tips/Questions |
| 2.4 | Tickets & Packages |
| 2.5 | Golf Tee Time Reservations and Recreation |
| 3.0 | Tour Guide |
| 4.0 | Photographer |
| 5.0 | My Vacation Folder (future) |
| 6.0 | My Convention (future) |
| 7.0 | General Requirements |

| | | |
|---|---|---|
| Basic Content | Additional Content | Advanced Content |

1.0 Intro Animated Clips and Interstitial Elements

| | |
|---|---|
| Attract loop that | If Guest does not |
| encourages the Guest | interact with the |
| to engage in the D-TV | system after a |
| system | predetermined time, |
| | D-TV will begin to |
| | cycle through Tour |
| | Guide video clips |
| Animated intro video | Alternate version of |
| (˜30 sec) | intro video for repeat |

| | |
|---|---|
| Plays only the first | Guests |

| | |
|---|---|
| time Guest uses the | Very slight change |
| TV during Length of | to intro video to |
| Stay | welcome Guests |
| Introduces the Tour | back if they have |
| Guide, Concierge | already visited WDW |
| and Photographer | Plays automatically |
| applications | if date of a prior visit |
| Will include a “replay | is known |
| intro” button | |
| Ends on D-TV home | |
| page | |

| Home page includes: | | Home page includes |
|---|---|---|
| | Guest's last name | other pertinent |
| | Links to: | information and |

| | |
|---|---|
| Tour Guide | pushed messages |

| | |
|---|---|
| Concierge | Weather |
| Photographer | Pushed marketing |
| | messages |

Home page includes
links to:

My Vacation Folder
My
Convention/Business
meeting

| | |
|---|---|
| Brief animated intros | “Goodbye” animation |
| (˜15 sec each) to the | displayed the first time |
| home page links; | the TV is turned on |
| intros only play the | during the Guest's last |
| first time the Guest | day: |

| selects that option | | Thanks Guests for |
|---|---|---|
| | Tour Guide | visiting |
| | Concierge | Recommends last |
| | Photographer | day activities |
| | | Provides link to “you |
| | | next vacation” video |
| | | clip |

| | |
|---|---|
| A series of ˜12 | Additional animated |
| transition animations | transitions to increase |
| (0-3 sec each) | the variety and fun of |

| | |
|---|---|
| Will be displayed | Character interaction |
| randomly in place of | with the Guest |

| | |
|---|---|
| longer intros after | Specific transitions |
| those have already | designed to play |
| been viewed | before, after or |
| Will serve as | between specific |
| transitions between | screens |
| different UI sections | Ability to track which |
| within D-TV | transitions have |
| | already been |
| | displayed to |
| | minimize repeat play |

| | |
|---|---|
| A single generic | Multiple versions of |
| animated background | backgrounds: |

| | |
|---|---|
| to display behind text- | Some to include |
| heavy screens | unexpected |
| | Character fun |
| | Some themed to |
| | specific areas within |
| | the UI |

2.0 Concierge UI

Dynamically
generated menu
screen that will enable
multiple options to be
displayed based on
availability of
applications:
Potential applications
include:

Dining
Transportation
Tickets
Tips

| | | |
|---|---|---|
| Link to Dining section | Link to transportation | Ability to import |
| will link to Dining | will launch | information such as |
| Finder content | transportation content | priority seating times |
| | Link to tickets will | to “My vacation folder” |
| | launch tickets content | or “My Convention” |
| | Link to tips will launch | page |
| | tips content. | |
| “Back” function to | | |
| return Guest to the | | |
| previous content area | | |

2.1 Dining Finder

| Simple UI to select a | | Integration with new |
|---|---|---|
| table service | | Dining Res system to |
| restaurant (TSR) by: | | enable Guest self- |
| | Property location | service booking of |
| | Cuisine | reservation |
| | Experience | |
| | (Show/Chr | |
| | breakfast, etc.) | |

| UI will default to | |
|---|---|
| relevant TSR choices | |
| based on how Guest | |
| navigated to the | |
| Dining Finder | |
| | (e.g., If the Guest |
| | chooses “Dining” |
| | from a page of MK |
| | info, MK dining |
| | options will be the |
| | default choices) |
| | Other dining |
| | options will be |
| | available to the |
| | Guest from the |
| | Dining finder |

| | |
|---|---|
| “Back” function to | |
| return Guest to the | |
| previous content area | |
| TSR detail display | In TSR detail display, |
| template containing | themed UI screens |
| the following data for | based on: |

| each TSR: | | Restaurant design |
|---|---|---|
| | Video overview | and logo, or |
| | (˜15 sec) | UI design criteria |
| | Graphic image of | (physical location, |
| | the menu | cuisine type or |
| | Logo of TSR | experience) |
| | Photo of TSR | |
| | P&S database | |
| | content: | |

Price
range (text)
Brief
description
(text)
Location
(text)

Priority seating
callback button to
enable Guest to
request a reservation
for the specific TSR
shown on-screen:

Guest enters:

Desired
day (defaults to
today)
Desired
time (defaults
to first
reservation
time for next
logical meal at
least one hour
after current
time)
Party size
(defaults to # of
Guests staying
in room)

System generates
a message to DRC
including above
plus:

TSR
currently being
viewed
Guest's
last name
Guest's
resort and
room #

DRC res agent
receives info and
calls Guest within
5 minutes to
confirm reservation
or help Guest find
an alternative

2.2 Transportation Finder

| | | |
|---|---|---|
| Text message | Simple UI to retrieve | Integration with real- |
| describing WDW | transportation | time bus routing and |
| transportation options | information for a given | tracking system to |
| and indicating Guest | WDW property | provide updates on |
| can receive driving | destination from a | when transportation |
| directions from the | given WDW starting | will arrive at hotel |
| Front Desk | point | |
| | UI will default to | Ability for Guest to |
| | relevant transportation | request transportation |
| | choices based on how | by any mode (bus, |
| | Guest navigated to | taxi, monorail, |
| | the transportation | watercraft, etc.) at a |
| | content | specific time and for a |

| | |
|---|---|
| (e.g., If the Guest | specific destination |
| chooses | |
| “Transportation” | |
| from a page of MK | |
| info, MK will be the | |
| default destination | |
| and the Guest's | |
| resort will be the | |
| default starting | |
| point) | |
| Other | |
| transportation | |
| destinations and | |
| starting points will | |
| be available to the | |
| Guest from the | |
| transportation | |
| application | |

| | |
|---|---|
| Results will be text- | Ability to show |
| based and will include | transportation routes |
| options for the Guest | on interactive maps |
| to view: | Ability to print |

| | | |
|---|---|---|
| | Recommended | transportation |
| | and alternative | information |
| | modes of Disney | Ability to download |
| | transportation | transportation |
| | Driving directions | information to a |
| | | wireless device |
| “Back” function to | | |
| return Guest to the | | |
| previous content area | | |

2.3 “Tips/Questions”

| | |
|---|---|
| View a video that | Interactive Q & A |
| compiles tips (such as | application that |
| Fast Pass, Finding | enables answers to |
| Characters, Pal | most frequently asked |
| Mickey, taking | questions. |
| pictures and general | |
| “insider” tips) | |
| “Back” function to | Contextual “tips” |
| return Guest to the | information integrated |
| previous content area | into appropriate |
| | places within D-TV |
| | applications |

2.4 Ticketing

| | | |
|---|---|---|
| Text description of all | Video overview(s) of | Ticketing information |
| ticketing packages | ticketing package | only appears if Guest |
| available for purchase | | has not already |
| at WDW | | purchased tickets |
| UI screen to select | | If a Guest has |
| ticket/package and | | purchased tickets or a |
| template for detail | | specific package, the |
| display | | entitlements only of |
| | | the Guest's specific |
| | | package would be |
| | | displayed |
| Messages to | Ticket sales engine | Sales engine |
| encounter Guests to | that enables Guest to | recommends ticket |
| purchase tickets at the | purchase available | packages or only |
| resort vs. at ticket | ticket packages | enables Guest to |
| windows | directly from the TV | purchase a relevant |

| | |
|---|---|
| Charge for tickets | package based on: |

| | |
|---|---|
| added directly to | Whether or not |
| Guest's hotel bill | Guest has already |
| Entitlements | purchased tickets |
| automatically | (upsell relevant |
| added to Guest's | options) |
| room key (no | Number of days |
| printed ticket or | left in Guest's stay |
| Cast-assisted | |
| process required) | |

| | |
|---|---|
| | Ability to provide user |
| | specific package |
| | entitlement |
| | information |
| | Tracking of which |
| | package entitlements |
| | a Guest has currently |
| | used and has left to |
| | use (distant future) |
| For events, provide | Sales of events tickets |
| phone number Guest | directly from TV |
| can call for ticketing | |
| information | |
| “Back” button for | |
| Guest to return to | |
| previous content | |
| screen | |

2.5 Golf Tee Time Reservations and Recreation

| | | |
|---|---|---|
| Video overview of | | |
| WDW Golf and | | |
| Recreation offerings | | |
| (see Tour Guide) | | |
| On screen text display | Leverage Dining Res | Integration with new |
| of phone number to | application | Tee Times reservation |
| call to book a tee time | functionality for tee | system to enable |
| | times | Guest self-service |
| | Tee time callback | booking of tee time |
| | button to enable | Extend application to |
| | Guest to request a tee | include other |
| | time: | recreation products |

Guest enters:

Desired
day (defaults to
today)
Desired
time (defaults
to first tee time)
Party size
(defaults to # of
Guests staying
in room)

System generates
a message to
Disney
Reservation
Center (DRC)
including above
plus:

Golf
course
currently being
viewed
Guest's
last name
Guest's
resort and
room #

| | |
|---|---|
| | DRC res agent |
| | receives info and calls |
| | Guest within 5 |
| | minutes to confirm tee |
| | time or help Guest |
| | find an alternative |
| “Back” function to | |
| return Guest to the | |
| previous content area | |

3.0 Tour Guide

| | |
|---|---|
| The first time the Guest | Automatically |
| accesses the Tour | determine which clip |
| Guide, play a “What's | to play based on date |
| New at WDW” video | of Guest's last visit |
| clip; Guest selects a clip | If date of last visit is |
| to watch: | not known, remember |

| | |
|---|---|
| For Guests who | which option Guest |
| have never been to | selects and use that |
| WDW | data where relevant |
| For Guests who last | throughout D-TV |
| visited 2-5 years ago | experience |
| For Guests who | |
| visited within the last | |
| 2 years | |

| | | |
|---|---|---|
| Simple UI enabling | Remember which | Create multiple |
| guests to select and | interest group Guest | versions of Property- |
| view marketing video | chooses the first time: | specific video clips |

| clips: | | Make that profile | based on interest |
|---|---|---|---|
| | WDW overview | the default for the | group |
| | video based on | rest of the Guest's | Show specifically |
| | user-selected | Length of Stay | edited clips to Guests |
| | interest group: | but . . . | based on their initial |

| | | |
|---|---|---|
| For Little | Enable Guests to | interest group |
| Ones | select other | selection |
| Disney | interest groups | Based on pre-arrival |
| Characters | during LENGTH | Guest data, |
| G-Rated | OF STAY | automatically |
| Thrills | | determine which |
| Extreme | | interest category(ies) |
| Thrills | | is/are relevant to the |
| Classics | | Guest and remove |
| Nightlife | | other interest group |

| | |
|---|---|
| Property-specific | menu options |
| video clips (edited | |
| for a generic WDW | |
| Guest). | |

Magic
Kingdom
Epcot
Disney/MGM
Studios
Animal
Kingdom
Downtown
Disney
Cirque du
Soleil
Golf and
Recreation

| | |
|---|---|
| Enable a Guest to quit | Enable trick play |
| out of a clip that is | mode to be an |
| currently playing | assignable parameter |
| | for each video clip: |

Fast forward
Rewind
Pause

| | |
|---|---|
| Template of P&S text | Theme template or |
| data will be displayed | background to match |
| based on video clip | Property area |
| being displayed: | selected |

This week's
operating hours
Show times
List of major
attractions,
including:

| | Brief | | |
|---|---|---|---|
| | description (text) | | |
| | Attraction | | |
| | logo | | |
| | Height | | |
| | requirements | | |
| | Fastpass | | |
| | info | | |
| | If attraction | | |
| | is closed for | | |
| | rehabilitation | | |
| Display a link to | | Do not display | |
| Concierge functions: | | Ticketing info if Guest | |
| | Tickets | already has tickets | |
| | Dining Finder | | |
| | Transportation | | |
| | | | Ability to import |
| | | | information to “My |
| | | | Vacation Folder” |

4.0 Photographer

| Short (˜2-minute) | |
|---|---|
| animated/live video to | |
| provide a tutorial of | |
| the functionality | |
| contained in the | |
| photographer section | |
| Menu screen with 3 | |
| options: | |
| | View your photos |
| | Purchase photos |
| | Share (email) |
| | photos |

“Back” function to
return Guest to the
previous content area
View photos: enable
the Guest to view
photographs from a
unique account

Scroll through
thumbnail sized
photos
Select a photo for
viewing at larger
size

E-commerce engine
to enable:

Select a photo
size/package
option for
purchase
Purchase reprints
of Guest film and
original Disney
photos
View multiple
pricing options
“View cart” of all
photos selected for
purchase
Edit cart and
increase or delete
photos from cart
Charge purchases
directly to guest's
hotel bill
Ability to produce
sales reports
Ability to produce
fulfillment and
tracking reports

Share Photos: An e-
mail engine to enable
emailing of photo
postcards to external
e-mail accounts

| | | |
|---|---|---|
| Choose photo of | | |
| Disney postcard | | |
| art or their own | | |
| photos | | |
| Select pre-written | | |
| message captions | | |
| Enable Guest to | | |
| enter recipient's e- | | |
| mail address using | | |
| the TV remote | | |
| control and virtual | | |
| keyboard | | |
| | Ability to customize | |
| | photos by adding | |
| | borders, character | |
| | artwork and pre- | |
| | written captions | |
| | Ability to save | |
| | customized images | |
| | into Guest's account | |
| | | Ability to create a |
| | | photo album for |
| | | purchase using the UI |
| | | Ability to create a |
| | | DVD using the UI |
| | | Ability to purchase |
| | | customized product |
| | | using the UI |

5.0 My Vacation Folder

On-site guest view of
“my vacation folder”
page
Ability to upload
information to the
vacation page
Other content

6.0 My Convention

Ability to personally
welcome
business/convention
guests
Ability to display real-
time agenda for
Convention Guest
meetings
Provide maps of
convention center
rooms
Other convention
specific content

7.1 General Requirements - Usage Metrics and Data Collection

| | | |
|---|---|---|
| Aggregated usage | Viewing hours logged: | Any reporting |

| data: | | Of D-TV mode | functions requiring |
|---|---|---|---|
| | Number of times | Of total time TV is | data from systems |
| | each content | on | other than the D-TV |
| | element is | Of TV by | system |

| | | |
|---|---|---|
| displayed | broadcast channel | Revenue reporting |

| | | |
|---|---|---|
| Number of times | Average # of viewer | Usage by a |
| each clickable | sessions: | specific Guest |

| | |
|---|---|
| element is | Per day |
| selected by the | Per Length of Stay |
| Guest | |
| For video clips, | |
| average viewing | |
| length per clip | |

Will leverage existing
data tracking tools
(Vignette, Hitbox, etc.)

| | |
|---|---|
| Click stream analysis | |
| of D-TV applications | |
| | Collection of data from |
| | specific Guests |

Collection of data
explicitly requested
by WDW and
entered by the
Guest
Usage behavior
tracking

| | | Integration of |
|---|---|---|
| | | individual Guest data |
| | | into other WDW data |
| | | systems |
| Minimum Requirement | Goal | Future Functionality |

7.1 General Requirements - Menu Generation

| | | |
|---|---|---|
| All menu lists will be | Intelligence to alter | Intelligence to alter |
| dynamically generated | menu screens based | menu screens based |
| to enable: | on: | on: |

| | | |
|---|---|---|
| Flexibility to | State of D-TV | External data |
| change number of | system (e.g. day | elements |
| items in any list | within Guest's | |
| Flexibility to | length of stay) | |
| change order of | Guest behavior | |
| elements within | within UI | |
| lists | Guest data (e.g. | |
| Automated | don't display a | |
| process to handle | “tickets” button if | |
| lists too long to fit | Guest has already | |
| on a single screen | purchased tickets, | |
| Support of multiple | show convention | |
| file types for menu | items only for | |
| items (text, | convention | |
| graphics, flash, | Guests, etc.) | |
| etc.) | | |
| Support of multiple | | |
| menu object sets | | |
| (e.g. multiple | | |
| languages or | | |
| themes) | | |

Creative elements for
multiple menu object
sets

Foreign languages
Favorite
characters,
themes, etc.

| | | Ability for Front Desk |
|---|---|---|
| | | Cast to set default |
| | | menu set for a specific |
| | | Guest room |
| Basic Content | Additional Content | Advanced Content |

7.2 General Requirements - Video Playback

| | | |
|---|---|---|
| Ability to replay video | Trick Play mode | Incorporation of pay- |
| clip after the clip ends | functionality as an | per-view movie |
| | assignable parameter | content to be played |
| | for each video clip | on-demand as |

| | |
|---|---|
| Pause | requested by guests. |
| Stop | Will include full-length |
| Rewind | feature films as well |
| Fast Forward | as animated and live |
| | action shorts. |

7.3 General Requirements - Conditional Access

Conditional access
code for pay services:

Pin number that
can be assigned
by Front Desk cast
member at Guest's
request
D-TV application
would require pin
number for
charges to be
billed to folio
account

The Basic Content that may be provided in the 1.0 Introduction (INTRO) using the D-TV system (remote and television) is disclosed. Additional Content that may be provided is shown in the foregoing Appendix, and Advanced Content is also shown in the foregoing Appendix.

The Concierge features, denoted by 2.0 through 2.5, again show Basic Content that may be provided along with Additional and Advanced Content. Under 2.1 Dining Finder, Experience (Show/Chr breakfast is a breakfast when a character associated with the venue will be present). In the last Column, RES indicates Reservation. DRC indicates Disney Reservation Center.

The Tour Guide Section 3.0 is shown in Basic Content, Additional Content and Advanced Content.

The Photographer Section 4.0 shows Basic Content, Additional Content and Advanced Content.

The My Vacation 22, 5.0 and the My Convention folder 23, 6.0, are illustrated in the following Appendix. Only Advanced Content is disclosed since these folders 22 and 23 may be provided in a future system.

Finally, General Requirements 7.0 of the System are listed in the Appendix, again showing Basic Content, Additional Content and Advanced Content. The General Requirements are broken down into Usage Metrics and Data Collection, Menu Generation and Video Playback.

It can be seen that there is disclosed an interactive television system that will be deployed in hotel rooms. The interactive television system will provide guests with entertaining and information interactive content designed to help reduce hassle and enhance the vacation experience. The guest room interactive television system will provide some of the types of services and functions typically found in many hotels throughout the world today. The guest room interactive television system will provide the guest with services such as a Tour Guide, Concierge and Photographer.

As Tour Guide, the guest room interactive television system will lead the guest through a personalized tour of what there is to see and do on their vacation. For example, the guest will be able to view video clips about nearby attractions and venues. They will also be able to see video clips that provide visitors information based on their individual preferences. During any of the video clips, guests will be able to get additional information at the touch of a button including show times, special events, and attraction specific information. Marketing videos may be selected and viewed.

As Concierge, the guest room interactive television system will help the guest with planning their time on their vacation. Functions in this section include a dining application that will allow the guest to make dining reservations, transportation information and a ticket-purchase application. Amusement park hours, for example, will be available and on-site access to further vacations at other venues may be available.

As Photographer, the guest room interactive television system will provide the guest the ability to view all of the photographs taken of them during their stay. They will also be able to edit, purchase and share their pictures via an easy-to-use application.

In an application entitled Management of the Flow of Persons in Relation to Centers of Crowd Concentration via Television Control, Ser. No. 10/687,226, filed Oct. 15, 2003, commonly assigned, there is disclosed a method and system for the loading of patrons at multiple attractions at an entertainment venue including the first-in first-out line and a priority based line. A cellular telephone may be used to obtain and claim priority status. In other forms, different priorities are established based on where, when and the number of priority spaces required. Different hierarchies are established for computer controlling the different lines for multiple attractions in the entertainment environment. The system and method also provide for moving people from an area of concentration to other locations. The system may be used to actually book other services associated with the venue, such as FASTPASS®, a system for arranging ticket reservations into one or more attractions at a venue on a priority basis. The system may include provisions for registering the cell phone of the guest to the venue to receive periodic updated information relating to the venue. This method and system may be incorporated in the Concierge section of the disclosure disclosed herein and is thus incorporated herein by reference.

Thus, the system disclosed herein can be used in conjunction with the aforementioned application to project actual venue utilization on any one particular day. Cast members associated with the venue can be placed in certain venue areas to meet demand. Guests could be directed to certain areas, such as transportation, restaurants, parks, attractions, etc. depending on the load demand. It may be suggested to the guest, for example, that restaurant A may be a better choice.

The system disclosed herein may be multilingual and may be associated with energy usage in the guest's room to manage the same.

Thus, there is disclosed an interactive television system used in hotel rooms at a venue adapted to provide the hotel guest with a tour guide to the venue, a virtual concierge for use by the guest while staying at the hotel and when visiting the venue, and a virtual photographer guide to the venue enabling the guest to view photographs taken of the guest when visiting the venue.

Animated characters may be used to depict the various stages of the system. Certain ones of the animated characters may be related to animated characters associated with the venue. Audio and video may be used throughout. The tour guide may include the provision of information on attractions at the venue and at other venues associated with the main venue and geographically distant from the main venue. For example, information on attractions and activities in the general area of the main venue may be provided.

The virtual concierge may include the provision of information relating to dining at the venue and transportation to and from the venue.

The virtual concierge may include ticket information for the guest while staying at the venue and prioritizing the visit of the guest to an attraction at the venue according to the concentration of visitors to the attraction.

The guest will interact with the system to select information displayed on the television set using a remote television control.

The virtual photographer may include the provision of allowing the guest to select any desired photographs being viewed by the guest and edit the same or transmit selected photographs to a remote location in the form of a photo, postcard, etc.

Although a particular embodiment of the disclosure is disclosed, variations thereof may occur to an artisan and the scope of the disclosure should only be limited by the scope of the appended claims. Thus, other embodiments may be utilized and structured and functional changes may be made without departing from the respective scope of the present disclosure.

1. An interactive television system used in hotel rooms at a venue adapted to provide the hotel guest with a tour guide to the venue, a virtual concierge for use by the guest while staying at the hotel and when visiting the venue, and a virtual photographer guide to the venue enabling the guest to view photographs taken when said guest visits the venue.

2. The system of claim 1 utilizing animated characters to depict the various stages of the system.

3. The system of claim 2 wherein certain of said animated characters are related to animated characters associated with said venue.

4. The system of claim 1 including the use of audio in said system.

5. The system of claim 1 wherein the tour guide includes the provision of information on attractions at the venue.

6. The system of claim 1 wherein the tour guide includes the provision of information on other venues associated with the venue and geographically distant from the venue.

7. The system of claim 1 wherein the tour guide includes the provisions of information on attractions and activities in the general area of the venue.

8. The system of claim 1 wherein the virtual concierge includes the provision of information relating to dining at the venue.

9. The system of claim 1 wherein the virtual concierge includes the provisions of information relating to transportation to and from the venue.

10. The system of claim 1 wherein the virtual concierge includes ticket information for the guest while staying at the venue and prioritizing the visit of the guest to an attraction at the venue according to the concentration of visitors to the attraction.

11. The system of claim 1 wherein the virtual concierge includes booking information relating to actually booking of a priority visit to an attraction at the venue.

12. The system of claim 1 wherein the virtual concierge includes a registration system associated therewith for registering the cell phone of a guest to the venue for providing the guest with periodic updated information relating to the venue.

13. The system of claim 1 including a remote television control associated with the system to allow a guest to interact with the system to select information displayed on a television set associated with the system.

14. The system of claim 1 wherein said virtual photographer includes the provision of allowing the guest to select any desired photographs being viewed by the guest and edit the same or transmit selected photographs to a remote location in the form of a photo, postcard, etc.

15. The system of claim 1 wherein the provisions of virtual concierge includes ticket information for the guest while staying at the venue.

16. The system of claim 1 wherein the provision of virtual concierge includes prioritizing the visit of the guest to an attraction at the venue according to concentration of visitors to said attraction.

17. The system of claim 1 wherein said system includes a television set including interacting means associated with the system for allowing the guest to interact with the system to select information displayed on the television set.

18. The system of claim 1 including interacting means associated with the system for allowing the guest to interact with the system to select information displayed on a television set associated with the system.

19. The system of claim 13 including interacting means associated with the system for allowing the guest to interact with the system to select information displayed on a television set associated with the system.

20. The system of claim 1 wherein the virtual photographer includes the provision of allowing the guest to select any desired photographs being viewed by the guest.

21. The system of claim 17 including the provision of editing means to allow the guest to edit any selected photographs.

22. The system of claim 17 including the provision of transmission means to allow the guest to transmit any of said selected photographs to a remote location.

23. A method for providing a hotel guest staying at a hotel when visiting a venue with a guide to the venue comprising the steps of:
providing a greeting to the hotel guest over a television set in the guest's hotel room;
providing interactive means between the guest and the television set allowing the guest to interact with information displaying on the television set;
providing a tour guide for the guest relating to the guest's stay at the venue over the television set;
providing a virtual concierge relating to the venue for the guest over the television set; and
providing a virtual photographer assistant to the guest over the television set relating to photographs taken of the guest during the guest's visit to the venue.

24. The method of claim 23 including using animated characters to depict the various stages of said guide.

25. The method of claim 24 wherein certain of said animated characters are related to animated characters associated with said venue.

26. The method of claim 2 including the use of audio in the various stages of said guide.

27. The method of claim 23 wherein the tour guide includes the provision of information on attractions at the venue.

28. The method of claim 23 wherein the tour guide includes the provision of information on other venues associated with the venue and geographically distant from the venue.

29. The method of claim 23 wherein steps of providing a tour guide includes the steps of providing information on attractions and activities in the general area of the venue.

30. The method of claim 23 wherein the virtual concierge includes the provision of information relating to dining at the venue.

31. The method of claim 23 wherein the virtual concierge includes provisions for prioritizing the guest's visit to a particular attraction at the venue according to concentration of visitors to said attraction.

32. The method of claim 23 wherein the virtual concierge includes the steps of booking a guest into an attraction at the venue on a prioritized basis.

33. The method of claim 23 wherein the virtual concierge includes the steps of registering the cell phone of a guest and providing the guest through the guest's cell phone with periodic updates relating to the venue.

34. The method of claim 23 wherein the virtual concierge includes the provisions of information relating to transportation to and from the venue.

35. The method of claim 23 wherein the provisions of virtual concierge includes ticket information for the guest while staying at the venue.

36. The method of claim 25 including interacting means for allowing the guest to interact with the system to select information displayed on the television set.

37. The method of claim 26 including interacting means for allowing the guest to interact with the system to select information displayed on the television set.

38. The method of claim 27 including interacting means for allowing the guest to interact with the system to select information displayed on the television set.

39. The method of claim 28 including interacting means for allowing the guest to interact with the system to select information displayed on the television set.

40. The method of claim 23 wherein the virtual photographer includes the provision of allowing the guest to select any desired photographs being viewed by the guest.

41. The method of claim 37 including the provision of editing means to allow the guest to edit any selected photographs.

42. The method of claim 37 including the provision of transmission means to allow the guest to transmit any of said selected photographs to a remote location.

43. An interactive system associated with a venue providing a guide to a visitor to the venue comprising of:
a tour guide associated with an interactive television system disposed in a room where said visitor is staying at said venue, said tour guide providing various services associated with the venue relating to rides, attractions and restaurants at the venue.
